(19) United States
(12) Patent Application Publication
(10) Pub. No.: US 2009/0114285 A1
(43) Pub. Date: May 7, 2009

(54) FLOW CHANNEL STRUCTURE, FLOW CHANNEL BOARD HAVING THE SAME, AND FLUID CONTROL METHOD

(76) Inventors: Gakuji Hashimoto, Kanagawa (JP); Masataka Shinoda, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/264,881

(22) Filed: Nov. 4, 2008

(30) Foreign Application Priority Data
Nov. 5, 2007 (JP) P2007-287337

(51) Int. Cl. A23G 9/28

(52) U.S. Cl. 137/13; 137/602

(57) ABSTRACT

A flow channel structure includes a first introduction part that introduces a sample, a second introduction part that introduces a fluid for sandwiching the sample, a discharge part that discharges the sample, a bent part at which a flow channel is bent at approximately 90 degrees around a Y axis, provided that an introduction direction of the sample is an X direction, and a bent part at which the flow channel is bent at approximately 90 degrees around an X axis.

### CROSS REFERENCES TO RELATED APPLICATIONS

The present invention contains subject matter related to Japanese Patent Application JP 2007-287337 filed in the Japanese Patent Office on Nov. 5, 2007, the entire contents of which being incorporated herein by reference.

### BACKGROUND OF THE INVENTION

1. Field of the Invention

The present invention relates to a flow channel structure. In particular, the present invention relates to a flow channel structure, a flow channel board having the same, and a fluid control method.

2. Description of the Related Art

A technology in which a small amount of sample flows in a micro flow channel and analysis of the sample is performed in the flow channel is widely used, starting with bio-related analysis or chemical analysis. For example, this technology is used in microchemical analysis of biologic materials or materials in natural environments.

Such a technology is used in, for example, flow cytometry. In the flow cytometry, cells or proteins are used as the sample, and analysis of the cells or proteins is performed in the flow channel. Sample division is continuously performed on the basis of the analysis result. In order to accurately sort the sample, it is important to continuously convey the sample in the flow channel in order.

In addition, for example, the measurement technology in the flow channel is used in chemical analysis as a microsystem technology. For example, it may be used in a microchemical analysis system that has the same micro flow channels as a fluid element on a board, and various detectors incorporated therein.

However, such a flow channel structure particularly has a problem in that a disturbance occurs due to a change in velocity distribution caused by a flow rate, and a transition from a laminar flow to a turbulent flow has a large effect. In order to solve such a problem, for example, in the flow cytometry, a predetermined flow channel structure is formed in a board, and a sample is sent while being sandwiched by a so-called sheath liquid from the left and right sides. In respects to such a flow channel structure, Anal. Chem. 2006, Vol. 78, 5653-5663 discloses a technology regarding a flow channel structure.

### SUMMARY OF THE INVENTION

In respects to fluid control, by causing the sample to be sandwiched by the fluid, a constant laminar flow is achieved in a direction to be sandwiched, but no laminar flow may be achieved in other directions. As a result, it maybe impossible to perform sufficient fluid control. Therefore, there is a need for a flow channel structure capable of performing fluid control with high accuracy.

An embodiment of the invention provides a flow channel structure including a first introduction part that introduces a sample, a second introduction part that introduces a fluid for sandwiching the sample, and a discharge part that discharges the sample. A flow channel at least has a bent part at which the flow channel is bent at approximately 90 degrees around a Y axis, provided that an introduction direction of the sample is an X direction, and a bent part at which the flow channel is bent at approximately 90 degrees around an X axis. With this flow channel structure having a three-dimensional shape, it is possible to cause the sample to be conveyed in the flow channel while being substantially concentrated on the central portion of the flow channel. In the flow channel structure, the flow channel may further include a bent part at which the flow channel is bent at approximately 90 degrees around a Z axis.

In the flow channel structure, the sectional shape of the flow channel in a convey direction of the sample may be substantially maintained to be the same. If the sectional shape is substantially the same in the flow channel, it is possible to effectively prevent the sample from clogging in the flow channel.

Another embodiment of the invention provides a flow channel board including the flow channel structure.

Yet another embodiment of the invention provides a fluid control method including the steps of, when a sample is conveyed in a flow channel while being sandwiched by a fluid, in an unordered sequence, bending the sample at approximately 90 degrees around a Y axis provided that an introduction direction of the sample is an X direction, and bending the sample at approximately 90 degrees around an X axis.

In the fluid control method, the position control of the sample in the flow channel may be performed by controlling a fluid condition of the sample or the fluid. By controlling a flow rate, it is possible to control the position of the sample flowing in the flow channel. As a result, it is possible to perform fluid control with higher accuracy.

In the fluid control method, the sample may include cells and/or beads, positional information of the cells and/or beads in the flow channel may be detected at a predetermined position in the flow channel, and the position control may be performed on the basis of the positional information. By detecting the positional information of the cells or beads, it is possible to perform more accurate position control.

According to the embodiments of the invention, it is possible to provide a flow channel structure that is capable of controlling a fluid with high accuracy.

### BRIEF DESCRIPTION OF THE DRAWINGS

FIG. 1 is a schematic perspective view illustrating a first embodiment of a flow channel structure according to the invention;

FIG. 2 is a schematic perspective view illustrating a state where a sample flows in a flow channel in the first embodiment;

FIG. 3 is a schematic perspective view illustrating a second embodiment of a flow channel structure according to the invention;

FIG. 4 is a schematic perspective view illustrating a third embodiment of a flow channel structure according to the invention;

FIG. 5 is a schematic perspective view illustrating a state where a sample flows in a flow channel in the third embodiment;

FIG. 6 is a side conceptual view illustrating an example of a method of manufacturing a flow channel board according to an embodiment of the invention;

FIG. 7 is a side conceptual view illustrating another example of a method of manufacturing a flow channel board according to an embodiment of the invention;

FIG. 8 is a conceptual view illustrating an FACS system using a flow channel board according to an embodiment of the invention;

FIG. 9 is a conceptual view illustrating the model of a flow channel structure in which analysis was performed;

FIG. 10 is a diagram illustrating a boundary condition of a fluid simulation for the model of the flow channel structure;

FIG. 11 is a diagram illustrating an analysis result of a fluid simulation for the model of the flow channel structure;

FIG. 12 is a conceptual view illustrating another model of a flow channel structure in which analysis was performed;

FIG. 13 is a diagram illustrating an analysis result of a fluid simulation for the model of the flow channel structure;

FIG. 14 is a diagram illustrating an analysis result for another model of a flow channel structure in which analysis was performed; and

FIG. 15 is a diagram illustrating a comparison result of connection structures (1) to (4).

### DESCRIPTION OF THE PREFERRED EMBODIMENTS

A flow channel structure, a flow channel board, and a fluid control method according to embodiments of the invention will be described with reference to the accompanying drawings. The accompanying drawings illustrate the representative examples of the invention, and should not be construed limiting the scope of the invention.

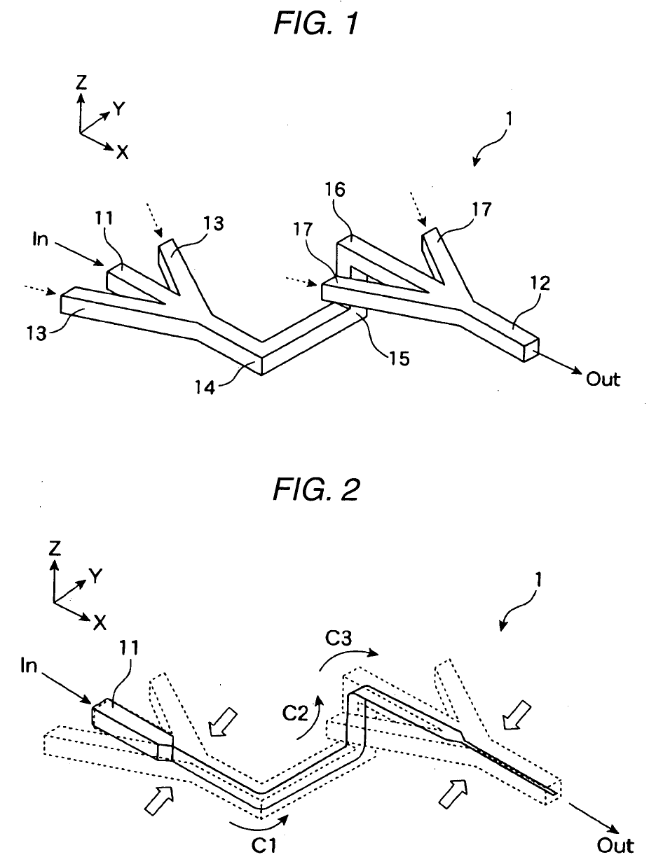

FIG. 1 is a schematic perspective view illustrating a first embodiment of a flow channel structure according to the invention. FIG. 2 is a schematic perspective view illustrating a state where a sample flows in a flow channel in the first embodiment. In the invention, a flow channel structure has a three-dimensional structure. A flow channel board including the flow channel structure may be simply obtained by bonding double-faced molded or single-faced molded boards described below.

Reference numeral 1 in FIG. 1 represents a flow channel structure 1. The flow channel structure 1 includes a first introduction part 11 that introduces a sample, and a discharge part 12 that discharges the sample. First, the sample is introduced into a flow channel through the first introduction part 11. A fluid is introduced through second introduction parts 13 and 13, and the sample is sandwiched by the fluid from the left and right sides. Thus, a sample liquid is formed.

The sample liquid is conveyed without change along an introduction direction of the sample (see an arrow). A bent part 14 is bent at approximately 90 degrees around a Z axis. Then, the sample liquid is bent and conveyed in a positive Y-axis direction while passing through the bent part 14. On the downstream side of the bent part 14, the flow channel is bent at approximately 90 degrees around an X axis at a bent part 15, such that the sample liquid is conveyed toward a position Z-axis direction while passing through the bent part 15. In addition, the flow channel is bent at approximately 90 degrees around a Y axis at a bent part 16, such that the sample liquid is conveyed in a position X-axis direction. Bending at approximately 90 degrees may be in a clockwise direction or counterclockwise direction, and a direction may be appropriately selected as occasion demands.

On the downstream side of the bent part 16, the fluid is further introduced through second introduction parts 17 and 17 to sandwich the sample liquid from the left and right sides. With this structure, the sample concentrated on the central portion of the flow channel in the flow channel structure 1 is conveyed from the discharge part 12.

The flow of the sample in the flow channel structure 1 will be described laying emphasis on FIG. 2. In FIG. 2, for convenience of explanation, the flow of the fluid or the like is indicated by a dotted line.

In the flow channel structure 1 shown in FIG. 1, the sample introduced through the first introduction part 11 is sandwiched by the fluid introduced through the second introduction parts 13, and the horizontal width thereof becomes narrow, as shown in FIG. 2. Then, after rotating at approximately 90 degrees around the Z axis, the sample liquid rotates at approximately degrees around the Y axis and the X axis, and accordingly the sectional shape thereof is narrow in a vertical direction (Z-axis direction). Further, the sample liquid is sandwiched again by the fluid introduced through the second introduction parts 17. Thus, a laminar flow in which the sample is concentrated on the central portion of the flow channel can be achieved (see signs C1, C2, C3, and Out in FIG. 2). That is, the sample is introduced through the first introduction part, and the fluid is introduced through the second introduction parts.

Therefore, it is possible to prevent the sample from being sent while being floated in the vertical direction (Z direction) in the flow channel, and to prevent the sample from colliding against or stuck to the wall surface of the flow channel in the vertical direction. In general, it is known that the velocity distribution in the section of the flow channel depends on Hagen-Poiseuille principle, that is, the velocity at the wall surface in the flow channel is low and the velocity at the central portion is high. In the flow channel structure according to the embodiment of the invention, it is possible to cause the sample liquid to pass through the central portion of the flow channel (see FIG. 2).

Since the sample flows in the central portion of the flow channel, it is possible to prevent the sample from colliding against the wall surface of the flow channel. In addition, it is possible to prevent the sample from being stuck to the wall surface of the flow channel and blocking the flow channel. Therefore, it is possible to achieve excellent stability in the velocity of the sample, the position of the sample in the flow channel, or the sequence of the samples to be conveyed. As a result, it is possible to maintain the velocity of the sample uniform in the flow channel.

What is necessary in order to concentrate the sample on the central portion of the flow channel structure 1 is that at least the bent part 15, which is bent at approximately 90 degrees around the X axis, and the bent part 16, which is bent at approximately 90 degrees around the Y axis, are provided in the flow channel. Meanwhile, when a branched flow channel structure is formed, the flow channel preferably has a bent part 14 that is bent at approximately 90 degrees around the Z axis provided that the introduction direction of the sample is an X direction (see FIG. 1), the bent part 15 that is bent at approximately 90 degrees around the X axis, and the bent part 16 that is bent at approximately 90 degrees around the Y axis.

In the flow channel structure according to the embodiment of the invention, the bending sequence or the number of bending times is not necessarily limited. For example, the flow channel structure shown in FIG. 1 may be used as a repetition unit or the bent part 15 that is bent at approximately 90 degrees around the X axis may be provided on the upstream side of the bent part 14 that is bent at approximately 90 degrees around the Z axis (not shown). As such, the bending sequence or the number of bending times may be appropriately selected in accordance with a measurement condition or a utilization condition.

In the flow channel structure 1 of this embodiment, where and how the second introduction parts 13 and 17 that introduce the fluid are provided are not limited, but in order to more accurately concentrate the sample on the central portion of the flow channel, at least two second introduction parts are preferably provided in the flow channel structure. More preferably, the second introduction parts 13 and 13 for initially sandwiching the sample from the left and right sides are preferably provided on the upstream side of the bent parts 14, 15, and 16. In addition, the second introduction parts 17 and 17 for secondary sandwiching the sample liquid from the left and right sides are preferably provided at positions on the downstream side of the bent parts 14, 15 and 16.

The shape of the flow channel in the flow channel structure 1 is not particularly limited, but in terms of the sample type, size, or shape, and the flow velocity to convey, the flow channel may be designed to have an appropriate shape. More preferably, the sectional shape of the flow change is substantially maintained to be the same. If the sectional shape of the flow channel is substantially maintained to be the same, it is possible to effectively prevent the sample from clogging in the flow channel or colliding against the wall surface.

The shapes of the bent parts 14, 15 and 16 in the flow channel structure are not limited. For example, a marginal length part (shift length) may be provided in a connection structure of the bent parts 14, 15 and 16 (not shown). By providing the marginal length part, it is possible to reduce a load on a manufacturing process. For example, when a plurality of boards are bonded to form the flow channel structure according to the embodiment of the invention, positioning of the boards when being bonded needs to be made with high accuracy. In contrast, by providing the marginal length part, it is possible to reduce such a load. This will be described below.

Similarly, the invention may be embodied as a fluid control method including the steps of, when a sample is conveyed in a flow channel while being sandwiched by a fluid, in an unordered sequence, (1) bending the sample at approximately 90 degrees around a Y axis, provided that an introduction direction of the sample is an X direction, and (2) bending the sample at approximately 90 degrees around an X axis. The fluid control method may be implemented by using the flow channel structure according to the embodiment of the invention.

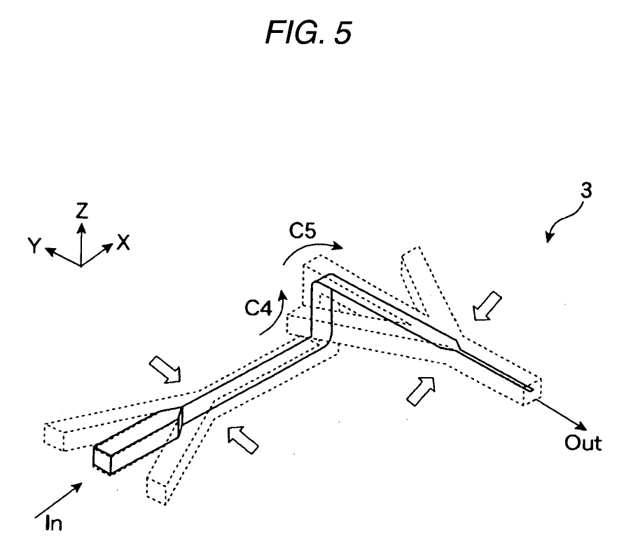

In the invention, it is preferable to sandwich the sample (or the sample liquid) by the fluid multiple times. Accordingly, it is possible to efficiently obtain a laminar flow. More preferably, the sample is sandwiched by the fluid to form the sample liquid, then the steps (1) and (2) are performed once or more, and subsequently the sample liquid is sandwiched by the fluid from the left and right sides. Therefore, it is possible to concentrate the sample liquid on the central portion of the flow channel. Of course, as occasion demands, the sample liquid may be further bent thereafter (for example, see FIGS. 4 and 5).

If the sample liquid is further bent at approximately 90 degrees around the Z axis (Step (3)), after the steps (1) to (3) are performed, the sample liquid may be further sandwiched by the fluid from the left and right sides (for example, see FIGS. 1, 2, and 3).

The position control of the sample in the flow channel may be performed by controlling a fluid condition of the sample or the fluid. While the sample is sandwiched by the fluid and conveyed in the flow channel, by controlling the fluid condition of the sample or the fluid, it is possible to cause the sample liquid to be conveyed with concentrated on the central portion of the flow channel. The fluid condition may include a physical condition, such as the flow rate, pressure (pressure at an inlet of the introduction part or pressure at an outlet of the flow channel), or specific gravity of the fluid, and adjustment in the width or length of the flow channel in the flow channel structure 1. That is, by changing the flow rate, pressure, width, and depth of a laminar flow forming flow channel of each layer, it is possible to arbitrarily control the positions of the cells or beads flowing in the flow channel. As a result, it is possible to stabilize the position of the sample in the flow channel or the flow velocity of the sample.

As the sample, any microparticles may be used, but not particularly limited. For example, cells, proteins, or beads may be used. In addition, preferably, positional information of the cells or beads in the flow channel is detected, and the position control of the sample is performed on the basis of the positional information. The positional information of the cells or beads may be detected at a predetermined position in the flow channel, and flow rate control may be performed on the basis of the positional information.

In the invention, examples of the sample may include the cells or beads. As the beads, various beads to be typically used may be appropriately used. Examples of the beads may include beads made of resin, such as polystyrene or beads made of glass. In addition, beads may be used which are obtained by mixing or coating fluorescent pigments, magnetic materials, various conductors, and optical materials on the surface of or in the beads. For example, resin beads, fluorescent beads, or magnetic beads may be used. The size or shape of the beads may be appropriately selected. For example, the beads may have an elliptic shape, a solid shape, or a rectangular parallelepiped shape, as well as to a spherical shape. Such beads may be selected in accordance with the physical properties to be measured.

Information to be used as the positional information is not particularly limited, for example, an optical property, an electrical property, and a magnetic property may be exemplified. By measuring the physical properties regarding the sample flowing in the flow channel, it is possible to obtain the positional information of the sample.

For optical property measurement, for example, fluorescence measurement, scattered light measurement, transmitted light measurement, reflected light measurement, diffracted light measurement, ultraviolet spectrometric measurement, infrared spectrometric measurement, Raman spectrometric measurement, FRET measurement, FISH measurement, and other various spectrum measurements may be used. When fluorescence measurement is used, if a fluorescent pigment may be made usable, and an additional fluorescent pigment having a different excitation wavelength is also used, it is possible to improve detection accuracy. In addition, as an example of position detection, measurement of a shift amount in focal depth of fluorescence, scattered light, reflected light, or transmitted light with respect to the cells or beads in the flow channel may be exemplified.

In the invention, the available electrical properties for measurement may include, for example, resistance, capacitance, and impedance regarding the sample, and a variation in electric field between electrodes. For example, electrical property information may be obtained by forming an electrical measurement element in a predetermined region in the flow channel and causing the sample to pass through the electrical measurement element. Then, on the basis of the electrical property information obtained in the above-described manner, it is possible to detect a position through which the sample passes in the flow channel. As an example of position detection, measurement of electrical resistance or impedance when opposing electrodes are arranged in a predetermined region in the flow channel and the sample passes through the electrodes may be exemplified.

In the invention, the available magnetic properties for measurement may include, for example, magnetization, change in magnetic field, and change in magnetizing field. In this case, for example, a sample with a magnetic material coated on the surface or magnetic beads may be used. Further, the magnetic beads are labeled with a fluorescent pigment as a single body. For example, measurement (or isolation) may be performed by causing cells, in which antibodies react with the magnetic beads, to pass through a predetermined region in the flow channel under a strong magnetic field. If a sample is caused to pass through opposing magnetic coils, a high-frequency spectrum which is a DC component or a high-frequency component of a generated magnetic field may be measured. Alternatively, a change in magnetization may be measured by using a magnetic resistive element.

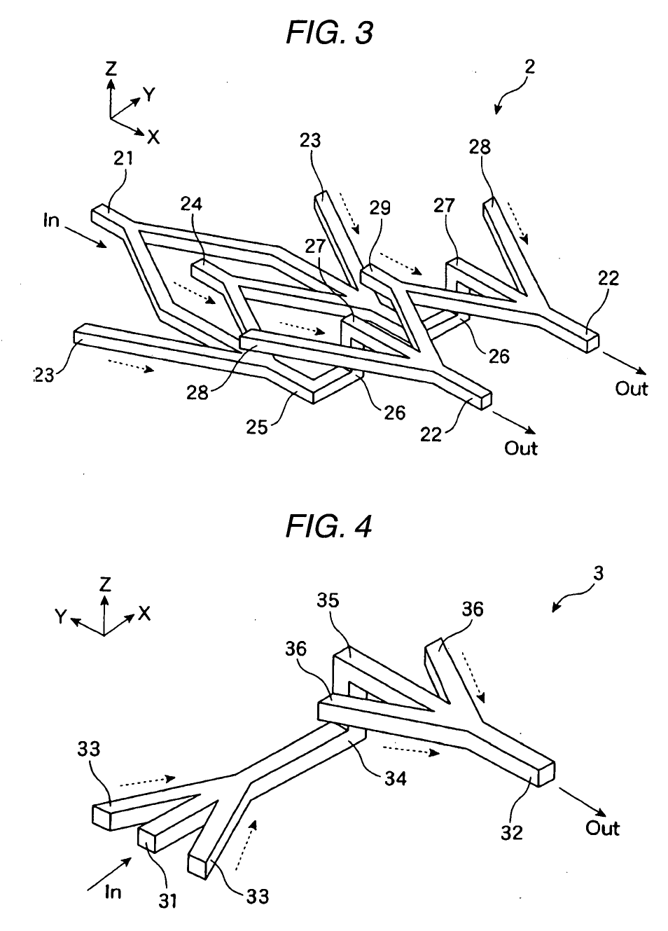

FIG. 3 is a schematic perspective view illustrating a second embodiment of a flow channel structure according to the invention. Reference numeral 2 in FIG. 3 represents a flow channel structure. The flow channel structure 2 is a branched flow channel structure. Hereinafter, a description will be provided laying emphasis on a difference from the foregoing first embodiment.

The flow channel structure 2 includes a first introduction part 21 that introduces a sample, and two discharge parts 22 and 22 that discharge the sample. First, the sample is introduced into the flow channel through the first introduction part 21 (see sign In of FIG. 3). Then, a fluid is initially introduced through the second introduction parts 23, 23, and 24, and the sample is sandwiched by the fluid from the left and right sides. Thus, a sample liquid is formed. In particular, the fluid introduced through the second introduction part 24 is branched and conveyed.

First, the sample liquid is bent at approximately 90 degrees around the Z axis at a bent part 25 and bent in the positive Y-axis direction. After passing through the bent part 25, the sample liquid is bent at approximately 90 degrees around the X axis at a bent part 26 and conveyed in the position Z-axis direction. Further, after passing through the bent part 26, the sample liquid is bent at approximately 90 degrees around the Y axis at a bent part 27 and again conveyed in the positive X-axis direction.

On the downstream side of the bent part 27, the fluid is secondarily introduced through second introduction parts 28, 28, and 29 to sandwich the sample liquid from the left and right sides. Therefore, the sample concentrated on the substantially central portion of the flow channel structure 2 is conveyed through the two discharge parts 22.

As such, the flow channel structure according to the embodiment of the invention may be appropriately implemented as a branched flow channel structure. In FIG. 3, the branched flow channel is bent toward the positive direction of any one of the X-axis direction, the Y-axis direction, and the Z-axis direction, but in terms of the shape of the board, the flow channel structure may be constructed such that the branched flow channels are bent in the negative direction on the individual axes. In addition, the arrangement sequence of the bent parts 26, 27, and 28 is just an example, and the bent parts may be arranged in a desired sequence within the scope of the invention.

FIG. 4 is a schematic perspective view illustrating a third embodiment of a flow channel structure according to the invention. FIG. 5 is a schematic perspective view illustrating a state where a sample flows in a flow channel in this embodiment. Reference numeral 3 in FIG. 4 represents a flow channel structure. The flow channel structure 3 does not include a bent part (for example, see the bent part 14 in FIG. 1) which rotates around the Z axis at approximately 90 degrees. Hereinafter, a description will be provided laying emphasis on a difference from the foregoing embodiments.

As described above, in the flow channel structure of this embodiment, the bent part around the Z axis is not necessarily provided insofar as a sample liquid is conveyed while being concentrated on the central portion of the flow passage. Accordingly, when it is not necessary to branch the flow channel, the flow channel structure 3 may be used. The flow channel structure 3 includes a first introduction part 31 that introduces a sample, and a discharge part 32 that discharges the sample. First, the sample is introduced into the flow channel through the first introduction part 31 (see sign In of FIGS. 4 and 5). And, a fluid is initially introduced through second introduction parts 33 and 33, and the sample is sandwiched by the fluid from the left and right sides. Thus, a sample liquid is formed (see FIG. 5).

The sample liquid is conveyed along the positive X-axis direction without change. The sample liquid is bent at approximately 90 degrees around the Y axis at a bent part 34 and bent in the positive Z-axis direction (see an arrow C4 of FIG. 5). Subsequently, the sample liquid is bent at approximately 90 degrees around the X axis at a bent part 35 and bent in the negative Y-axis direction (see an arrow C5 of FIG. 5). On the downstream side of the bent part 35, the fluid is secondarily introduced through second introduction parts 36 and 36 to sandwich the sample liquid from the left and right sides. Therefore, it is possible to convey the sample while being concentrated on the central portion of the flow channel in the flow channel structure 3.

The flow of the sample in the flow channel structure 3 will be described. In FIG. 5, for convenience of explanation, the flow of the fluid is indicated by a dotted line. In the flow channel structure 3 shown in FIG. 5, the sample introduced through the first introduction part 31 is initially sandwiched by the fluid introduced through the second introduction parts 33 and 33. Accordingly, the sample liquid has a narrow shape when viewed from the X-axis direction in front view. Subsequently, after passing through the bent parts 34 and 35, the sample liquid is secondarily sandwiched by the fluid introduced through the second introduction parts 36 and 36. Therefore, it is possible to concentrate the sample on the central portion of the flow channel. As a result, it is possible to achieve a laminar flow, in which the sample only exists in the central portion of the flow channel, with high accuracy (see sign Out of FIG. 5).

In the flow channel structure 3 of this embodiment, where and how the second introduction parts 33 and 36 that introduce the fluid are provided are not limited, but in order to efficiently obtain a laminar flow, at least two second introduction parts for introducing the fluid are preferably provided in the flow channel structure. The introduction parts 33 and 33 for initially introducing the fluid are preferably provided on the upstream side of any one of the bent parts. In addition, the introduction parts 36 and 36 that secondarily introduce the fluid for sandwiching the sample liquid from the left and right sides are preferably provided at positions on the downstream side of the bent parts.

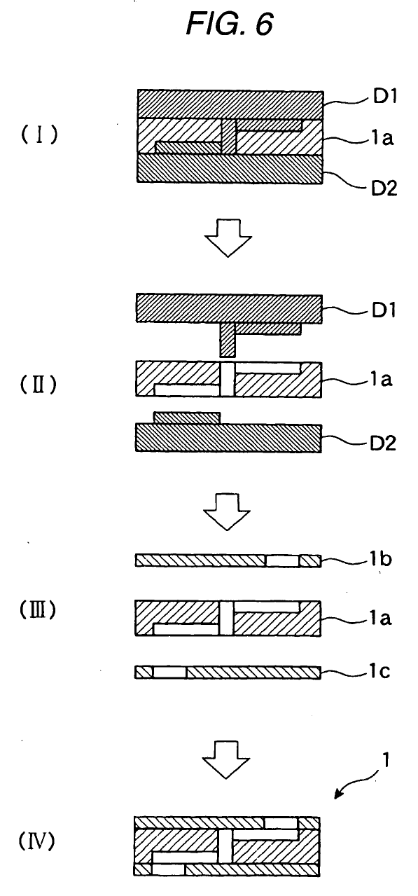

FIG. 6 is a side conceptual view illustrating an example of a method of manufacturing a flow channel board according to an embodiment of the invention. The flow channel board of this embodiment may also be simply manufactured by injection molding using a double-faced mold. FIG. 6 shows a manufacturing method using a double-faced mold as an example of a method of manufacturing a flow channel board according to an embodiment of the invention. Hereinafter, a description will be provided in a process sequence.

In respects to a board 1a, an upper mold D1 and a lower mold D2 having a flow channel shape and a through hole shape (see the first introduction part 11 and the discharge part 12 in FIG. 1) are placed in an injection molding machine (not shown), and shape transfer to the board 1a is performed.

In the injection molded board 1a, a flow channel structure and a through hole shape are formed (see sing (II)). In addition, injection molded boards 1b and 1c are bonded to both faces of the board 1a (see (III)). Therefore, it is possible to simply manufacture a flow channel board 1 according to an embodiment of the invention (see (IV)).

In respects to double-faced molding, known methods may be appropriately used. By double-faced molding, it is possible to form the structure of the bent parts at one time, and thus it is possible to suppress misalignment when being bonded.

In bonding the boards 1a, 1b, and 1c, known methods may be appropriately used. In respects to bonding, when thermal welding, an adhesive, anodic bonding, or an adhesive sheet is used, plasma activated coupling or ultrasonic coupling may be appropriately used. An appropriate bonding method may be selected in accordance with the shape or size of the board.

Though not shown, surface treatment may also be performed on the surface of the injection molded board 1a (see (II)). Therefore, it is possible to control the physical property of the surface of the flow channel, such as a hydrophobic property.

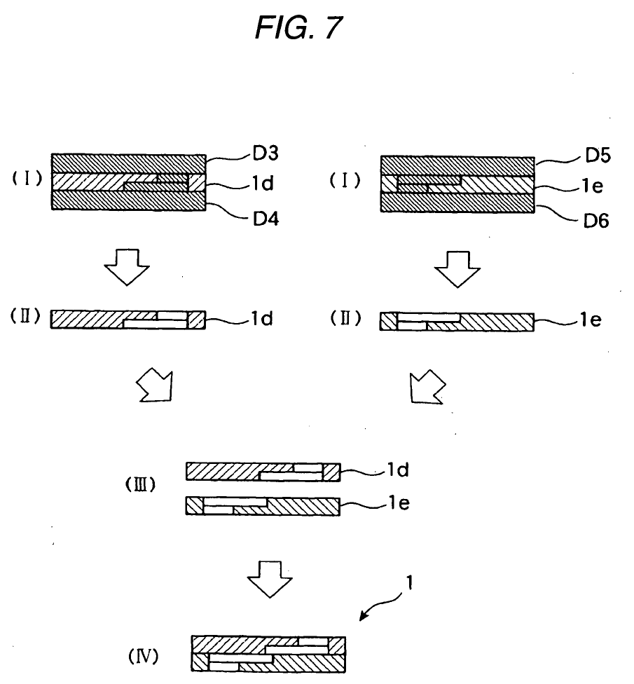

FIG. 7 is a side conceptual view illustrating another example of a method of manufacturing a flow channel board according to an embodiment of the invention. The flow channel board of this embodiment may be simply manufactured by bonding double-faced molded boards. FIG. 7 shows a manufacturing method using double-faced molded boards as an example of a method of manufacturing a flow channel board according to an embodiment of the invention. The same as the above-described manufacturing method will be omitted, and only a difference will be described. Hereinafter, a description will be provided in a process sequence.

In respects to a board 1d, an upper mold D3 and a lower mold D4 having a flow channel shape and a through hole shape (see the first introduction part 11 and the discharge part 12 of FIG. 1) are placed in an injection molding machine (not shown), and shape transfer to the board 1d is performed (see (I)). In the double-faced molded board 1d, a flow channel structure and a through hole shape are formed (see (II)). In addition, a board 1e is formed in the same manner. And, the two boards 1d and 1e are bonded to each other (see (III)). Therefore, it is possible to simply manufacture a flow channel board 1 according to an embodiment of the invention (see (IV)).

The method of manufacturing a board is not limited to double-faced molding, but single-faced molding may also be used. In respects to single-faced molding, known methods, such as so-called plate punching, may be appropriately used, but in terms of molding accuracy, double-faced molding is preferably used. As such, if a board uses the flow channel structure according to an embodiment of the invention, it is possible to manufacture a flow channel board capable of performing fluid control with high accuracy by a simple method, such as injection molding using a double-faced mold.

In particular, it is possible to simply manufacture the flow channel board of this embodiment by injection molding using a double-faced mold and a bonding process of a cover sheet. Of course, it may be possible to simply manufacture the flow channel board of this embodiment by injection molding using a single-faced mold and a board bonding process. Therefore, it is possible to manufacture a flow channel board capable of performing fluid control with high accuracy at low manufacturing costs. As such, the flow channel structure or the flow channel board according to an embodiment the invention has the manufacturing advantages.

In bonding the boards to each other, it is necessary to accurately position the boards (see (III) of FIG. 6 or 7). Above all, in the micro flow channel, the positioning accuracy of the boards is an important factor. For high positioning accuracy, however, if a positioning method for a semiconductor chip is used, manufacturing costs may be increased, and it is difficult to manufacture a flow channel structure at low cost. In order to overcome this problem, a marginal length part is preferably provided in the bent part of the flow channel structure according to an embodiment of the invention. By providing the marginal length part, even if a minute error in bonding occurs when bonding, it is possible to reduce the influence. The shape of the marginal length part may be designed in terms of misalignment when bonding. For example, the marginal length part is preferably provided to protrude by a predetermined length from each bent part in an opposite direction to a direction in which the flow channel is bent.

In manufacturing a flow channel board according to an embodiment of the invention, materials or methods for injection molding may be appropriately selected. As the board, moldable resins may be used, regardless of the types. For example, thermosetting resin may be used. Specifically, polymethyl methacrylate or silicon resin may be exemplified. When spectrometric analysis is conducted on the flow channel board, light-transmissive resin is preferably used. In addition, an injection molded board using low-melting-point glass or nanoimprinting using UV curable resin may be used.

The invention may be used in various fields as technology for fluid control, and the sample or fluid may be selected in accordance with the purpose. As the fluid, any material may be used insofar as it is capable of sandwiching and conveying a target sample, regardless of the type. Therefore, in terms of the nature of a material to be used as the sample, the fluid may be appropriately selected. Further, if necessary, an additive may be added.

For example, in the flow cytometry, the cells, proteins, or beads may be used as the sample, and a sheath solution, such as a normal saline solution, may be used as the fluid. In addition, when the board is used for various analyzers or micro reactors, if various oils, organic solvents, or electrolytes are used as the fluid, it is possible to enable crystallization of nanoemulsions, nanocapsules, and various samples, chemical composition or component analysis of hazardous materials.

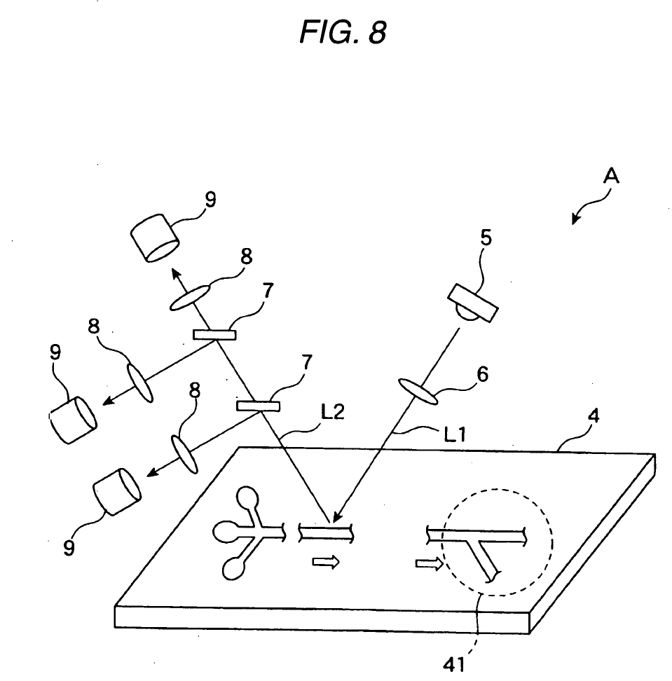

FIG. 8 is a conceptual view of an FACS system using a flow channel board according to an embodiment of the invention. Symbol A of FIG. 8 represents an FACS (Fluorescence Activated Cell Sorting) system. The FACS system A serves as an optical detection system and irradiates light onto the sample in the flow channel.

Samples in a flow channel board 4 are conveyed through the central portion of the flow channel with sandwiched by a fluid. A sample flow including the samples to be measured and a sheath flow are injected into the flow channel of the flow channel board 4 at regular pressure (flow velocity), and thus the flow in which the cells are arranged in line is formed. Then, excited light L1 is emitted from a light source 5 and irradiated onto the samples, which are conveyed through the flow channel of the flow channel board 4, through a condensing lens 6.

If excited light L1 is irradiated onto the samples, fluorescence or forward scattered light (FCS) is generated. Light components of specific wavelengths are separated from return light L2 by dichroic mirrors 7 and 7, which are provided on a concentric optical path, and band pass filters 8, 8, and 8. Then, a detector 9 (for example, a photo multiplier tube (PMT)) may detect the individual wavelengths. Therefore, it is possible to perform spectrometric analysis of the sample in the flow channel.

Though not shown, when a desired sample is found from the analysis result, only a desired cell may be extracted at a branched region on the downstream side of the flow channel. For sample extraction, various sample extraction methods using a piezoelectric element or an electromagnetic valve may be used. Here, for example, a case where sample extraction laser is used will be described.

The sample extraction laser is separately irradiated at optimum timing and irradiation power on the basis of information acquired by a spectrometric detector (for example, fluorescent spectrum, size, and velocity). Then, air bubbles are generated by optical energy irradiated into the flow channel. The air bubbles result in a change in the flow of the flow channel, such that only a desired sample may be guided to a target extraction area.

As such, the FACS system A may perform spectrometric analysis on the cells serving as the samples by laser light, determine whether or not a desired cell exists, and extract only the desired cell in the branched flow channel (see reference numeral 41). In such a branched flow channel structure, according to the invention, it is also possible to perform fluid control with high accuracy (for example, see FIGS. 3 and 4).

Even when a detection system such as the FACS system A and a sample extraction system are spaced at a predetermined distance from each other, in order to specify the position of a sample to be extracted from among the samples conveyed to a sample extraction part, it is important to make the flow velocity of the samples uniform. In respects to this, in the flow channel structure according to an embodiment of the invention, it is possible to continuously arrange and convey the samples in the flow channel. As a result, it is possible to accurately sort the samples. In addition, the flow velocity of the samples flowing in the flow channel or the position of the sample in the flow channel is stabilized, and thus it is possible to perform stable spectrometric analysis or sample extraction.

Although the application to the FACS system is illustrated, for the overall analysis chip which requires the position or velocity control of the sample to be observed, the invention may be effectively used. As the applications, for example, various DNA analysis instruments, mass spectrometers, and other real-time cell observation instruments may be exemplified. The invention may also be applied to various analyzers or micro reactors.

### EXAMPLES

The effects of the flow channel structure according to the embodiment of the invention were verified. Specifically, for the flow channel structure according to the embodiment of the invention, computer analysis was performed. This fluid analysis was performed by using a finite volume method-based thermo-fluid analysis tool, “ANSYS-CFX”, which is manufactured by ANSYS Inc. in U.S.A. Unless expressly so defined, the number of elements used for discretization is about 3 hundred thousand in any models, and the boundary condition, mesh quality, and calculation accuracy are the same.

### Example 1

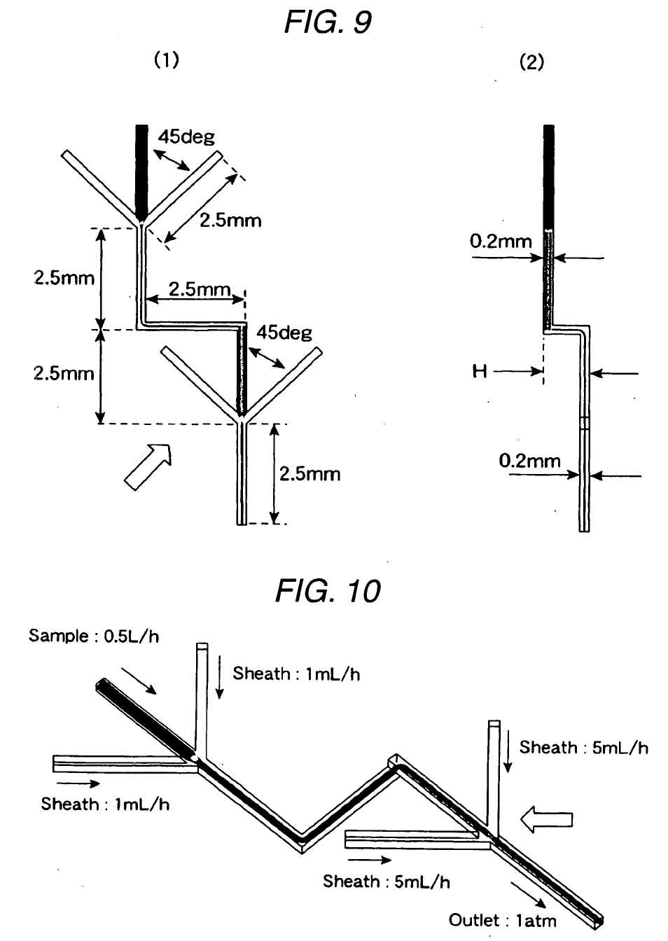

For the model of the flow channel structure shown in FIG. 9, computer analysis was performed. FIG. 9 is a schematic view illustrating the model of the flow channel structure. In FIG. 9, (1) shows the flow channel structure in top view, and (2) shows the flow channel structure when viewed from the right side in side view. The flow channel structure shown in FIG. 9 has three bent parts (for example, see FIG. 1). Moreover, the size or shape shown in FIG. 9 is just an example for the simulation, but it is not intended to limit the size or the like of the flow channel structure according to the embodiment of the invention (the same is applied to the following description).

FIG. 10 shows a boundary condition of a fluid simulation for the flow channel structure. Moreover, FIG. 10 shows a state when viewed obliquely from a direction indicated by an arrow of FIG. 9. As shown in FIG. 10, the flow velocity of a sample flow was 0.5 mL/h, the flow velocity of a first sheath flow 1 mL/h, the flow velocity of a second sheath flow 5 mL/h, and pressure when being discharged 1 atm.

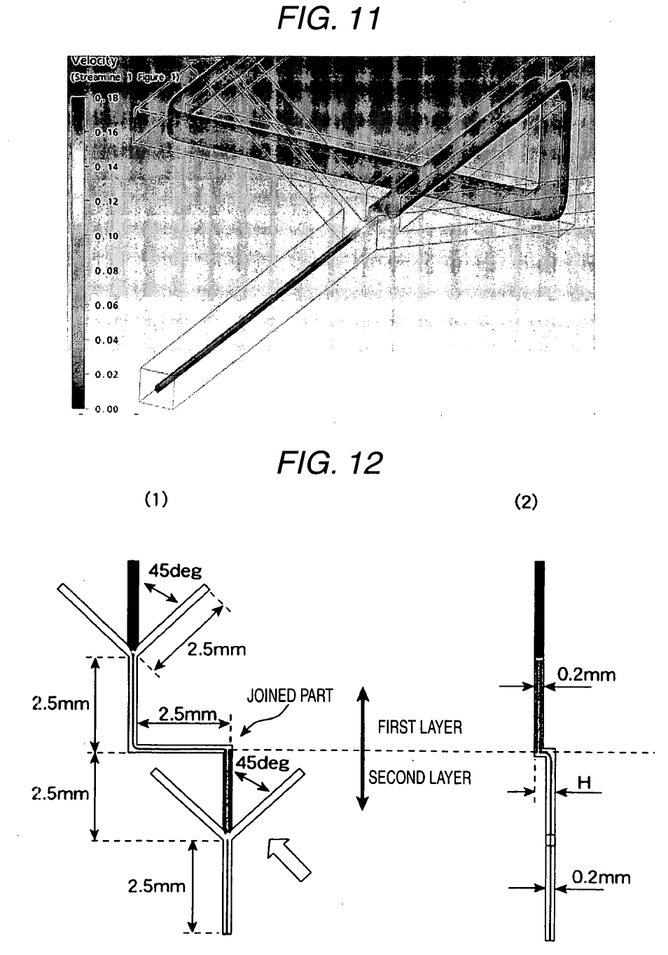

The analysis result of the fluid simulation is shown in FIG. 11. Moreover, FIG. 11 shows a state when viewed obliquely from a direction indicated by an arrow of FIG. 10. FIG. 11 shows a manner (Stream Line) in which the sample flow flows in the flow channel. The gray color of the sample flow represents the flow velocity. From this, it can be seen that the sample flow passing through the three bent parts shows uniform flow velocity distribution even in three-dimensional view, and flows while being concentrated on the central portion of the flow channel.

### Example 2

For the model of the flow channel structure shown in FIG. 12, computer analysis was performed. FIG. 12 is a schematic view illustrating the model of the flow channel structure. In FIG. 12, (1) shows the flow channel structure when viewed in top view, and (2) shows the flow channel structure when viewed from the right side in side view. The flow channel structure shown in FIG. 12 has three bent parts. Moreover, the size or shape shown in FIG. 12 is just an example for the simulation, but it is not intended to limit the size or the like of the flow channel structure according to the embodiment of the invention.

The flow channel structure has a structural feature in that, as will be apparent from (2) in FIG. 12, the height of the flow channel in the Z-axis direction is the minimum. In FIG. 12, observation may be performed with the flow channel divided into two layers at a joined part. This flow channel structure may be obtained by bonding two molded micro analysis chips.

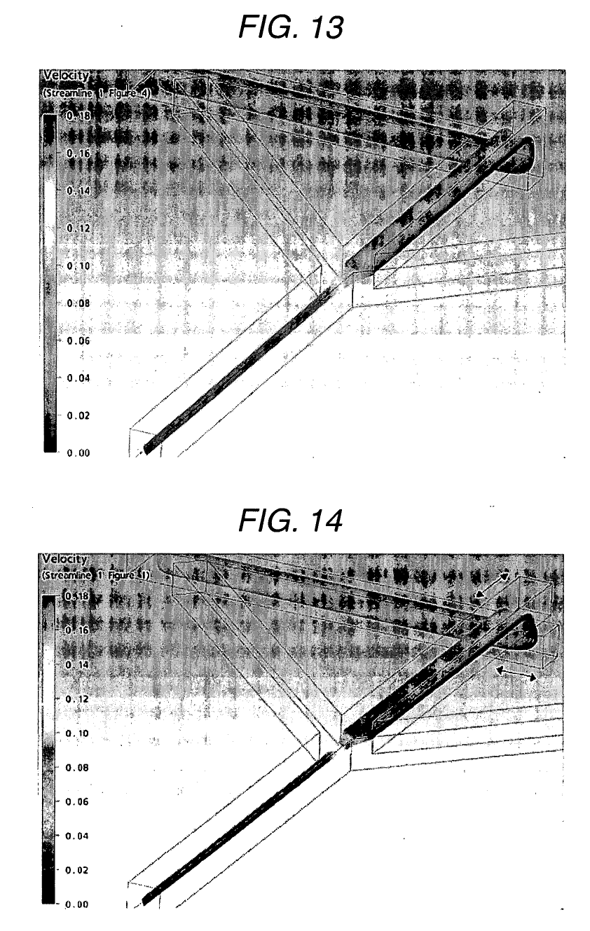

The analysis result of the fluid simulation is shown in FIG. 13. Moreover, FIG. 13 shows a state when viewed obliquely from a direction indicated by an arrow of FIG. 13. FIG. 13 shows a manner (Stream Line) in which the sample flow flows in the flow channel. In this example, the simulation was conducted on the same condition as the analysis mode of Example 1. Therefore, in this example, the sample flow passing through the three bent parts also uniform flow velocity distribution even in three-dimensional view, and flows while being concentrated on the central portion of the flow channel.

### Example 3

For the model of the flow channel structure shown in FIG. 14, computer analysis was performed. In the flow channel structure shown in FIG. 14, a connection portion of the flow channel is bonded with a marginal length (protruded length) of 0.1 mm in the Y-axis direction and the X-axis direction (see an arrow of FIG. 14). Other parts are the same as those in FIG. 12.

As a result, in Example 3, the sample flow passing through the three bent parts also shows uniform flow velocity distribution even in three-dimensional view, and flows while being concentrated on the central portion of the flow channel. Therefore, it can be seen that, even if a certain error in bonding occurs, it is possible to ensure a good sample flow shape.

From the above examination result, it can be seen that, in consideration of a case where the flow channel structure according to the embodiment of the invention is obtained by bonding a plurality of injection molded boards, a margin of a predetermined length is preferably provided in each bent part of the flow channel structure.

In the related art, bonding technology with high accuracy is needed, and in terms of manufacturing costs, an excessive load is imposed. In contrast, in the flow channel structure according to the embodiment of the invention, it is possible to enable fluid control with high accuracy and to significantly reduce a load in manufacturing. That is, only if an injection molded board is manufactured so as to a margin of a predetermined length in advance, it is possible to simply and reliably manufacture a flow channel board capable of performing fluid control with high accuracy.

### Example 4

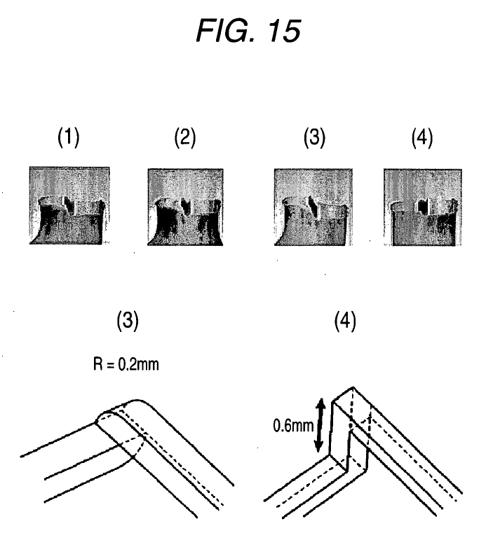

For a connection structure of bent parts, a comparative experiment was conducted so as to examine the structure of the bend part in the flow channel structure. In various connection structures (1) to (4) shown in FIG. 15, a fluid simulation was performed on the same condition as described above, and the influence of the connection structures to the fluid was examined.

The connection structure 1 is the bent part of the flow channel structure for which the simulation was performed in Example 1.

The connection structure 2 is the bend part of the flow channel structure for which the simulation was performed in Example 3.

In the connection structure 3, the connection portion of the flow channel is bonded with a marginal length (protruded length) of 0.1 mm in the Y-axis direction and the X-axis direction. That is, a predetermined marginal length is provided in an opposite direction to a direction in which the flow channel is bent. Other parts are the same as those of the model in Example 3.

In the connection structure 4, a relay channel of H=0.6 mm is provided in the connection portion of the flow channel while the flow channel is bent. Other parts are the same as those of the model in Example 3.

The simulation results of the connection structures are shown in FIG. 15, and the comparison result is shown in Table 1.

TABLE 1
Comparison Result of Connection Structures

| Connection Structure | | Sectional Shape | Bonding Shape | Calculation Result |
|---|---|---|---|---|
| 1 | Example 1 | Section □ 0.2 mm | — | ◯ |
| | (Normal) | | | |
| 2 | Example 3 | Section □ 0.2 mm | X-axis - 0.1 mm | ◯ |
| | (Connection with Shift) | | Y-axis - 0.1 mm | |
| 3 | R-Face Connection | Section □ 0.2 mm | R = 0.2 mm | Δ |
| 4 | Double-Faced Molded | Section □ 0.2 mm | H = 0.6 mm | [symbol] |

In FIG. 15 and Table 1, the double-faced molded connection structure 4 was best evaluated. The shapes of the connection structures 1 and 2 were well evaluated at the same extent. In addition, the connection structure 3 having an R shape was able to perform fluid control for practical use, but as compared with other connection structures 1, 2, and 4, it was slightly worse evaluated.

As described above, with the findings of the connection structure 4, it can be seen that, if a relay channel is provided while the flow channel is bent, it is possible to more stabilize the flow. For example, as shown in (2) of FIG. 9 and the like, the distance (height H) between the bent flow channel and the flow channel are preferably at a predetermined distance. This structure may be simply obtained by, particularly, double-faced molding (for example, see (III) of FIG. 6).

When a board flow channel is formed by typical bonding, misalignment is likely to occur. In this case, like the connection structure 2, if a predetermined marginal length is provided in a direction opposite to the bent direction, it is possible to ensure stability at the same extent as the connection structure 1 or the like.

As described, it can be seen through the examples that according to the invention, it is possible to perform fluid control with high accuracy in the flow passage.

It should be understood by those skilled in the art that various modifications, combinations, sub-combinations and alterations may occur depending on design requirements and other factors insofar as they are within the scope of the appended claims or the equivalents thereof.

What is claimed is:

1. A flow channel structure comprising:
a first introduction part that introduces a sample;
a second introduction part that introduces a fluid for sandwiching the sample;
a discharge part that discharges the sample;
a bent part at which a flow channel is bent at approximately 90 degrees around a Y axis, provided that an introduction direction of the sample is an X direction; and
a bent part at which the flow channel is bent at approximately 90 degrees around an X axis.

2. The flow channel structure according to claim 1, further comprising:
a bent part at which the flow channel is bent at approximately 90 degrees around a Z axis.

3. The flow channel structure according to claim 1,
wherein the sectional shape of the flow channel in a convey direction of the sample is substantially maintained to be the same.

4. A flow channel board comprising the flow channel structure according to claim 1.

5. A fluid control method comprising the steps of, when a sample is conveyed in a flow channel while being sandwiched by a fluid, in an unordered sequence:
bending the sample at approximately 90 degrees around a Y axis, provided that an introduction direction of the sample is an X direction; and
bending the sample at approximately 90 degrees around an X axis.

6. The fluid control method according to claim 5,
wherein the position control of the sample in the flow channel is performed by controlling a fluid condition of the sample or the fluid.

7. The fluid control method according to claim 6,
wherein the sample includes cells and/or beads, positional information of the cells and/or beads in the flow channel is detected at a predetermined position in the flow channel, and the position control is performed on the basis of the positional information.
